(19) United States
(12) Patent Application Publication
(10) Pub. No.: US 2025/0153627 A1
(43) Pub. Date: May 15, 2025

(54) AUTOMOTIVE PROTECTIVE MAT AND METHOD FOR MANUFACTURING AUTOMOTIVE PROTECTIVE MAT

(71) Applicant: Li HUANG, Guangzhou (CN)

(72) Inventor: Li HUANG, Guangzhou (CN)

(73) Assignee: Guangzhou Dingdian Technology Co., Ltd., Guangzhou (CN)

(21) Appl. No.: 19/023,377

(22) Filed: Jan. 16, 2025

(51) Int. Cl. B60N 3/04; B29C 48/00; B29C 48/08; B29C 48/21; B29K 23/00; B29K 105/00; B29K 225/00; B29L 31/30; B32B 27/08; B32B 27/30; B32B 27/32; B32B 37/10; B32B 37/14; B32B 37/15; B32B 38/00; B32B 38/06; B60R 13/01

(52) U.S. Cl. CPC B60N 3/04; B29C 48/022; B29C 48/08; B29C 48/21; B32B 27/08; B32B 27/302; B32B 27/32; B32B 37/10; B32B 37/144; B32B 37/153; B32B 38/0004; B32B 38/06; B60R 13/01; B29K 2023/06; B29K 2023/12; B29K 2105/0088; B29K 2225/04; B29L 2031/3017; B32B 2250/03; B32B 2250/246; B32B 2250/40; B32B 2270/00; B32B 2323/04; B32B 2323/10; B32B 2325/00

(57) ABSTRACT

An automotive protective mat and a method for manufacturing same are provided. The automotive protective mat includes a mat body. The mat body includes two elastic layers and a composite reinforcement layer. The composite reinforcement layer is located between the two elastic layers. The elastic layers and the composite reinforcement layer are laminated. The method for manufacturing the automotive protective mat includes: first extruding two layers of thermoplastic elastomer materials that are in molten states by using one extruder, and extruding a layer of composite material that is in a molten state by using another extruder. Then aggregating the three layers of materials in a composite die head, and extruding the materials under a pressure. Then pressing a plate by using two molding embossing rollers to form a plate including two elastic layers and a composite reinforcement layer; and finally cutting the plate to form the automotive protective mat.

### TECHNICAL FIELD

The present disclosure relates to the field of automobile accessories, and in particular, to an automotive protective mat and a method for manufacturing an automotive protective mat.

### BACKGROUND OF THE INVENTION

In the field of automobile parts, an automotive protective mat is a key assembly that protects components inside an automobile from wear, stains, and various potential damages during daily use. Furthermore, with the continuous development of the automobile industry and the increasing awareness of motor vehicle maintenance, a requirement for the performance of the automotive protective mat is increasingly high.

At present, on the market, there are mainly two types of automotive protective mats that use thermoplastic elastomer materials. One type is an automotive protective mat that only uses a single thermoplastic elastomer material, and the other type is an automotive protective mat that is generated by mixing a thermoplastic elastomer material with another hard material. For the automotive protective mat that only uses the single thermoplastic elastomer material, due to the soft nature of the material itself, it feels comfortable on feet. When used as an automotive floor mat, the automotive protective mat can bring a relatively soft experience to a driver and a passenger. When the automotive protective mat is used as a pickup truck bed mat, this soft nature can also provide buffering and protection for an item placed on the mat without an external force. However, due to its softness, when used as the automotive floor mat, the automotive protective mat may not well fit a complex shape inside the automobile. Especially at edges, the automotive protective mat may not be straight. When the automotive protective mat is used as the pickup truck bed mat, it is difficult for the mat to well match the shape of a hopper, and the mat easily deforms by an external factor. For example, during driving of a vehicle, the mat may be blown to deform or even fly away. During loading and unloading of goods, like dragging dinning plates on tablecloth, the mat is easily pulled to deform and cannot maintain its original shape and position. For the automotive protective mat that is generated by mixing the thermoplastic elastomer material with another hard material. By incorporating the hard material, the original rubber-like texture of the thermoplastic elastomer material disappears and is replaced by a plastic-like texture, resulting in poor friction and inferior slip performance. Meanwhile, the addition of the hard material reduces the elasticity. When folded, the surface of the material tends to tear easily because it doesn't have enough elasticity. Furthermore, this reduction in elasticity is not conducive to recovery of the original shape after folding, i.e. recovery becomes poor, and the overall toughness is also reduced due to the change in material properties.

Therefore, the present disclosure provides an automotive protective mat and a manufacturing method thereof, which can effectively solve the above problems. The automotive protective mat has excellent fitness and stability, and good texture, friction, wear resistance, restoration ability, and toughness.

### SUMMARY OF THE INVENTION

In order to overcome the shortcomings of the prior art, the present disclosure provides an automotive protective mat and a manufacturing method thereof. The automotive protective mat has excellent fitness and stability, and good texture, friction, wear resistance, restoration ability, and toughness.

The technical solution adopted by the present invention to solve the technical problem is as follows.

The present invention provides an automotive protective mat. The automotive protective mat includes a mat body. The mat body includes two elastic layers and a composite reinforcement layer; the composite reinforcement layer is located between the two elastic layers, and the elastic layers and the composite reinforcement layer are laminated; a shore hardness of the composite reinforcement layer is greater than a shore hardness of each elastic layer; each elastic layer is made of a thermoplastic elastomer material, and the composite reinforcement layer is made of a composite material; components of the composite material include a thermoplastic elastomer material and a polyolefin material; and in the composite material, the thermoplastic elastomer material accounts for 50% to 60%, and the polyolefin material accounts for 40% to 50%.

As an improvement of the present invention, each elastic layer is made of a styrene thermoplastic elastomer material.

As an improvement of the present invention, the thermoplastic elastomer material in the composite material is a styrene thermoplastic elastomer material.

As an improvement of the present invention, the polyolefin material in the composite material includes a polyethylene material and a polypropylene material.

As an improvement of the present invention, the polyethylene material in the composite material accounts for 20%; the polypropylene material in the composite material accounts for 20%; and the styrene thermoplastic elastomer material in the composite material accounts for 60%.

As an improvement of the present invention, the polyethylene material in the composite material accounts for 25%; the polypropylene material in the composite material accounts for 25%; and the styrene thermoplastic elastomer material in the composite material accounts for 50%.

As an improvement of the present invention, the polyethylene material in the composite material accounts for 25%; the polypropylene material in the composite material accounts for 20%; and the styrene thermoplastic elastomer material in the composite material accounts for 55%.

As an improvement of the present invention, antiskid patterns are arranged on one side of one of the elastic layers facing away from the composite reinforcement layer.

As an improvement of the present invention, the mat body is integrally formed.

The present invention also provides a method for manufacturing an automotive protective mat, comprising the following steps:

S1: first extruding two layers of thermoplastic elastomer materials that are in molten states by using one extruder, and extruding a layer of composite material that is in a molten state by using another extruder, components of the composite material include a thermoplastic elastomer material and a polyolefin material; and in the composite material, the thermoplastic elastomer material accounts for 50% to 60%, and the polyolefin material accounts for 40% to 50%;

S2: aggregating the three layers of materials in a composite die head, and extruding the materials under a pressure;

S3: pressing the thermoplastic elastomer materials and the composite material by using two molding embossing rollers to form a plate including two elastic layers and a composite reinforcement layer, each elastic layer is made of the thermoplastic elastomer material, and the composite reinforcement layer is made of the composite material; and

S4: cutting the plate to form the automotive protective mat.

As an improvement of the present invention, step S3a is further included between step S3 and step S4: pulling the plate by using a pulling device.

As an improvement of the present invention, the extruders are heated to make the thermoplastic elastomer materials and the composite materials reach a temperature 170 DEG C to 230 DEG C and in molten states; and flow velocities of the thermoplastic elastomer materials flowing out of the extruder and a flow velocity of the composite materials flowing out of the extruder are controlled at 300 to 500 KG/h.

As an improvement of the present invention, a distance between the two molding embossing rollers is 1.5 to 5.0 mm.

As an improvement of the present invention, a pulling speed of the pulling device is 0.8 to 11 meters/minute.

As an improvement of the present invention, the thermoplastic elastomer material in the composite material is a styrene thermoplastic elastomer material, and the polyolefin material in the composite material includes a polyethylene material and polypropylene material.

As an improvement of the present invention, the polyethylene material in the composite material accounts for 20%; the polypropylene material in the composite material accounts for 20%; and the styrene thermoplastic elastomer material in the composite material accounts for 60%.

As an improvement of the present invention, the polyethylene material in the composite material accounts for 25%; the polypropylene material in the composite material accounts for 25%; and the styrene thermoplastic elastomer material in the composite material accounts for 50%.

As an improvement of the present invention, the polyethylene material in the composite material accounts for 25%; the polypropylene material in the composite material accounts for 20%; and the styrene thermoplastic elastomer material in the composite material accounts for 55%.

As an improvement of the present invention, patterns are arranged on the molding embossing rollers.

As an improvement of the present invention, one of the variable-frequency control systems controls flow velocities of the thermoplastic elastomer materials flowing out of the composite die head, a flow velocity of the composite material flowing out of the composite die head, and speeds of the molding embossing rollers; the flow velocities of the thermoplastic elastomer materials flowing out of the composite die head and the flow velocity of the composite material flowing out of the composite die head are 25 to 50 meters/minute; and the speeds of the molding embossing rollers are 9.0 to 12 meters/minute.

Beneficial effects of the present invention are as follows. Through the arrangement of the above structure, the automotive protective mat has excellent fitness and stability, and good texture, friction, wear resistance, restoration ability, and toughness.

### BRIEF DESCRIPTION OF DRAWINGS

In order to explain the technical solutions of the embodiments of the present invention more clearly, the following will briefly introduce the accompanying drawings used in the embodiments. The drawings in the following description are only some embodiments of the present invention. Those of ordinary skill in the art can obtain other drawings based on these drawings without creative work.

The present invention is further described below in detail in combination with the accompanying drawings and embodiments.

FIG. 1 is a schematic diagram of an entire structure of an automotive protective mat according to the present disclosure;

FIG. 2 is a flowchart of a method for manufacturing an automotive protective mat according to the present disclosure; and

FIG. 3 is a flowchart of adding step S3a into a method for manufacturing an automotive protective mat according to the present disclosure.

### DETAILED DESCRIPTION OF THE INVENTION

To make the aforementioned objectives, features, and advantages of the present disclosure more comprehensible, specific implementations of the present disclosure are described in detail below in conjunction with the accompanying drawings. In the following description, numerous specific details are set forth to provide a thorough understanding of the present disclosure. The present disclosure may, however, be embodied in many forms different from that described here. A person skilled in the art can make similar improvements without departing from the connotation of the present disclosure. Therefore, the present disclosure is not limited by the specific embodiments disclosed below.

In the description of the present disclosure, It is to be understood that, The terms “center”, “longitudinal”, “transverse”, “upper”, “lower”, “front”, “rear”, “left”, “right”, “vertical”, “horizontal”, “top”, “bottom”, “inner”, “outer”, “clockwise”, “counterclockwise”, and the like indicate azimuth or positional relationships based on the azimuth or positional relationships shown in the drawings, For purposes of convenience only of describing the present disclosure and simplifying the description, Rather than indicating or implying that the indicated device or element must have a particular orientation, be constructed and operated in a particular orientation, therefore, not to be construed as limiting the present disclosure.

In addition, the terms “first” and “second” are used for descriptive purposes only, while not to be construed as indicating or implying relative importance or implicitly specifying the number of technical features indicated thereby, features defining “first,” “second,” and “second” may explicitly or implicitly include one or more of the described features. In the description of the present disclosure, “multiple” means two or more unless explicitly specified otherwise.

In addition, the terms “install”, “arrange”, “provide”, “connect” and “couple” should be understood broadly. For example, it can be a fixed connection, a detachable connection, an integral structure, a mechanical connection, an electrical connection, a direct connection, an indirect connection through an intermediate medium, or a communication between two devices, elements or components. For ordinary technical personnel in this field, the specific meanings of the above terms in present disclosure can be understood based on specific circumstances.

In the present disclosure, unless specific regulation and limitation otherwise, the first feature “onto” or “under” the second feature may include the direct contact of the first feature and the second feature, or may include the contact of the first feature and the second feature through other features between them instead of direct contact. Moreover, the first feature “onto”, “above” and “on” the second feature includes that the first feature is right above and obliquely above the second feature, or merely indicates that the horizontal height of the first feature is higher than the second feature. The first feature “under”, “below” and “down” the second feature includes that the first feature is right above and obliquely above the second feature, or merely indicates that the horizontal height of the first feature is less than the second feature.

It should be noted that when an element is referred to as being “fixed to” another element, the element can be directly on another component or there can be a centered element. When an element is considered to be “connected” to another element, the element can be directly connected to another element or there may be a centered element. The terms “inner”, “outer”, “left”, “right”, and similar expressions used herein are for illustrative purposes only and do not necessarily represent the only implementation.

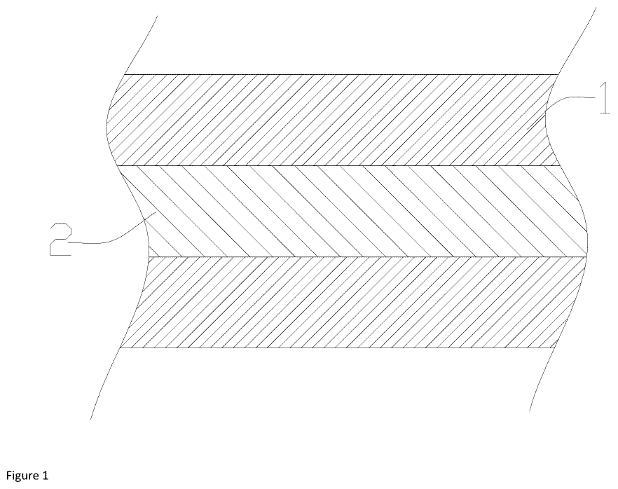

Referring to FIG. 1, the present disclosure provides an automotive protective mat, including: a mat body, wherein the mat body includes two elastic layers 1 and a composite reinforcement layer 2; the composite reinforcement layer 2 is located between the two elastic layers 1, and the elastic layers 1 and the composite reinforcement layer 2 are laminated; a shore hardness of the composite reinforcement layer 2 is greater than a shore hardness of each elastic layer 1; each elastic layer 1 is made of a thermoplastic elastomer material, and the composite reinforcement layer 2 is made of a composite material; components of the composite material include a thermoplastic elastomer material and a polyolefin material; and in the composite material, the thermoplastic elastomer material accounts for 50% to 60%, and the polyolefin material accounts for 40% to 50%.

Through the arrangement of the above structure, the automotive protective mat is rigid inside and soft outside, so that the automotive protective mat has excellent fitness and stability, and good texture, friction, wear resistance, restoration ability, and toughness.

When the automotive protective mat of the present disclosure is used as an automotive floor mat, the elastic layers 1 of this protective mat can adaptively deform according to a contour of a floor in an automobile, to closely fit every corner and curvature and perfectly fit regions in complex shapes such as an automobile door sill and a position below a seat. Meanwhile, the higher shore hardness of the composite reinforcement layer 2 ensures that the foot mat can remain stable under various driving operations. Even if the vehicle accelerates, brakes or turns sharply, the foot mat will not slide, curl, or move.

When the automotive protective mat of the present disclosure is used as the automotive floor mat, the elastic layers 1 made of the thermoplastic elastomer materials can bring a user a high-end texture experience, improve the overall comfort level and luxury of the automobile, and further provide appropriate friction on a surface of the floor mat to prevent a passenger from slipping when the passenger gets on and off the automobile, thus ensuring the safety and freedom of movement of the passenger.

When the automotive floor mat of the present disclosure is used as the automotive floor mat, if a heavy object is placed on the mat, such as a heavy luggage carried by the passenger, the elastic layers 1 of the mat may deform according to a shape and pressure of the heavy object, or to mount the foot mat, if the foot mat needs to be bent or stretched appropriately to adapt to a specific spatial layout inside the automobile, the joint action of the elastic layers 1 and the composite reinforcement layer 2 makes the foot mat to quickly recover to its original shape, and the toughness of the protective mat can ensure that the protective mat will not be easily broken or damaged.

When the automotive protective mat of the present disclosure is used as a pickup truck bed mat, a shape and size of a cargo hopper of a pickup truck or a truck are often irregular, and the truck may bump and vibrate during transportation. The elastic layers 1 of this protective mat can tightly fit various shape changes in a bottom and side wall of the cargo hopper. The elastic layers can well fit curved corners or rugged surfaces. Furthermore, during transportation of heavy building materials such as bricks and cement bags, the protective mat can be adaptively adjusted according to shapes and stacking modes of goods to ensure stable placement of the goods. Meanwhile, the composite reinforcement layer 2 can enhance the structural strength of the entire protective mat, keeping the protective mat stable during driving of the vehicle. Even when the vehicle runs on a rough mountain road or a bumpy road, the protective mat will not wander or be blown in the cargo hopper, which effectively prevents the goods from slipping, colliding, and being damaged due to the movement of the protective mat, and ensures the safety and stability of goods transportation.

When the automotive protective mat of the present disclosure is used as the pickup truck bed mat, if goods with surfaces that are easily scratched need to be transported, the elastic layers 1 of the protective mat provide soft buffering protection to avoid scratches, wear, and other damages caused by direct contact between the goods and a hard surface of the cargo hopper. The frictional force on the surface of the protective mat can prevent the goods from sliding and colliding with each other during transportation. For example, during transportation of a batch of glass products, the frictional force between pieces of glass and between the glass and a wall of the cargo hopper can keep the glass products in a relatively fixed position, thereby reducing the risk of glass breakage caused by vibration and shaking, and ensuring the integrity of the goods during transportation.

When the automotive protective mat of the present disclosure is used as the pickup truck bed mat, the cargo hopper often loads various rough, heavy, and sharp-edged goods in daily use, such as steel and gravels for construction. These goods cause severe wear on the pickup truck bed mat. The composite reinforcement layer 2 of this protective mat has excellent wear resistance and can withstand repeated friction, scratching, and high pressure of the goods. For example, during long-term transportation of the gravels, continuous friction and rolling of the gravels on the protective mat will not easily break the protective mat. Even after high-intensity use for multiple times, the protective mat can still maintain its basic protective function. This greatly reduces the costs and trouble of frequent replacement of the pickup truck bed mat due to wear. In addition, during transportation of large and heavy goods, the protective mat can quickly recover to its original shape after the goods are unloaded. Its good toughness can also ensure that the protective mat will not be torn or damaged and will always maintain the complete protective performance and meet transportation needs of goods in various shapes and sizes.

In this embodiment, each elastic layer 1 is made of a styrene thermoplastic elastomer material.

The two elastic layers 1 are made of the styrene thermoplastic elastomer materials, so that the automotive protective mat of the present disclosure can maintain good performance even in an environment with a large temperature change. At a high temperature, the automotive protective mat may not be excessively softened and adhered like some other thermoplastic elastomer materials. In a low-temperature environment, the automotive protective mat will not become too brittle and lose elasticity.

In this embodiment, the thermoplastic elastomer material in the composite material is a styrene thermoplastic elastomer material.

By using the styrene thermoplastic elastomer material as one of the components of the composite material, due to the characteristic of the molecular structure of the styrene thermoplastic elastomer material, the styrene thermoplastic elastomer material can be better blended with the polyolefin material. During manufacturing, when the materials are extruded through extruders and aggregated in a composite die head, a uniform composite structure can be formed, which helps avoid the problems such as material delamination and separation, making the performance of the composite reinforcement layer 2 more stable and reliable.

In this embodiment, the polyolefin material in the composite material includes a polyethylene material and a polypropylene material.

By using the polyethylene material and the polypropylene material as the components of the composite material, due to their high hardness and rigidity, the polyethylene material and the polypropylene material can provide a necessary supporting force for the protective mat in the composite reinforcement layer 2 of the automotive protective mat.

For example, when the automotive protective mat of the present disclosure is used as the automotive floor mat, this hardness can keep the foot mat in a stable shape during the driving of the vehicle. Even when a passenger frequently gets on and off the vehicle or moves the feet on the foot mat, the foot mat will not easily deform. As the pickup truck bed mat, the protective mat can be prevented from being crushed by a heavy object during loading of the heavy object, ensuring stable placement of the goods.

In this embodiment, the polyethylene material in the composite material accounts for 20%; the polypropylene material in the composite material accounts for 20%; and the styrene thermoplastic elastomer material in the composite material accounts for 60%.

By setting the above ratios, it is possible to further improve the flexibility of the automotive protective mat using the ratios, which is suitable for a scenario with a high flexibility requirement.

In this embodiment, the polyethylene material in the composite material accounts for 25%; the polypropylene material in the composite material accounts for 25%; and the styrene thermoplastic elastomer material in the composite material accounts for 50%.

By setting the above ratios, the flexibility and rigidity of the automotive protective mat using the ratios can be moderate, making it suitable for a scenario that require moderate flexibility and rigidity.

In this embodiment, the polyethylene material in the composite material accounts for 25%; the polypropylene material in the composite material accounts for 20%; and the styrene thermoplastic elastomer material in the composite material accounts for 55%.

By setting the above ratios, it is possible to further improve the rigidity of the automotive protective mat using the ratios, which is suitable for a scenario with a high rigidity

In this embodiment, antiskid patterns are arranged on one side of one of the elastic layers 1 facing away from the composite reinforcement layer 2.

By the arrangement of the above structure, the antiskid performance of the automotive protective mat can be further improved, and the patterns can also increase the aesthetic appeal of the automotive protective mat.

In this embodiment, the mat body is integrally formed.

By the arrangement of the above structure, the mat body of the automotive protective mat has a compact structure, without any gaps of layering or splicing. In the multi-layer structured protective mat, the composite reinforcement layer 2 and the two elastic layers 1 are integrated as a whole, without any weak parts caused by gluing or mechanical splicing.

For example, during long-term use, especially as the automotive floor mat that is frequently treaded, or as the pickup truck bed mat that is pressed and frictionized by the goods, the layers will not be separated, thus ensuring the structural integrity and stability of the protective mat.

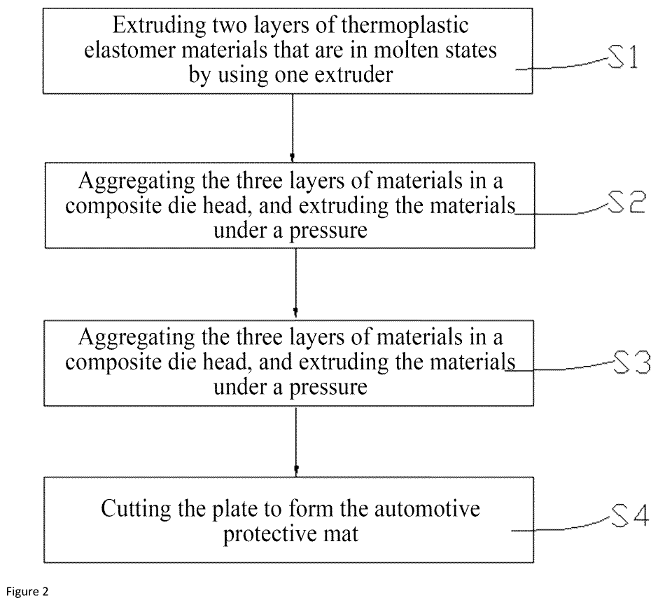

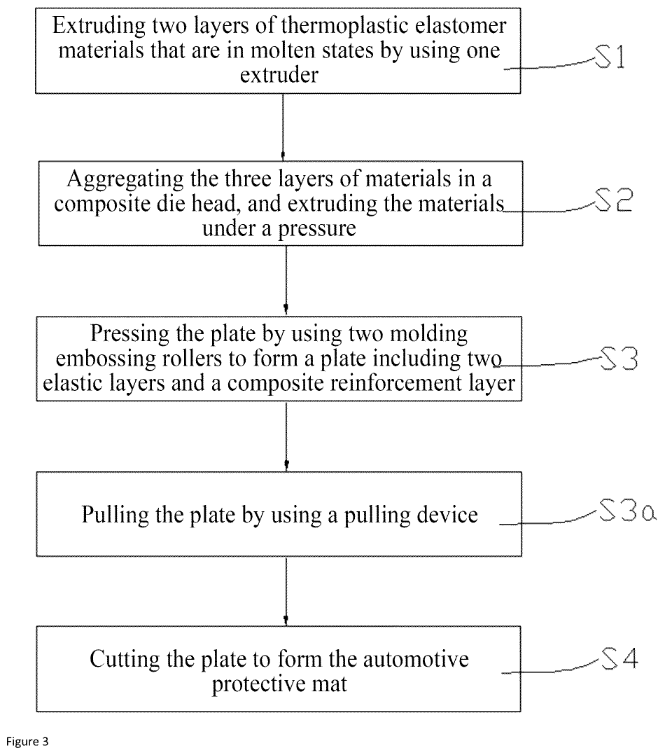

Referring to FIG. 1 to FIG. 3, the present disclosure further provides a method for manufacturing an automotive protective mat, including the following steps:

S1: first extruding two layers of thermoplastic elastomer materials that are in molten states by using one extruder, and extruding a layer of composite material that is in a molten state by using another extruder, wherein components of the composite material include a thermoplastic elastomer material and a polyolefin material; and in the composite material, the thermoplastic elastomer material accounts for 50% to 60%, and the polyolefin material accounts for 40% to 50%;

S2: aggregating the three layers of materials in a composite die head, and extruding the materials under a pressure;

S3: pressing the thermoplastic elastomer materials and the composite material by using two molding embossing rollers to form a plate including two elastic layers 1 and a composite reinforcement layer 2, wherein each elastic layer 1 is made of the thermoplastic elastomer material, and the composite reinforcement layer 2 is made of the composite material; and

S4: cutting the plate to form the automotive protective mat.

The automotive protective mat manufactured by the above method is rigid inside and soft outside, so that the automotive protective mat has excellent fitness and stability, and good texture, friction, wear resistance, restoration ability, and toughness.

In this embodiment, step S3a is further included between step S3 and step S4: pulling the plate by using a pulling device.

Through the above settings, the speed of the plate flowing out of the composite die head can be accurately adjusted according to an actual production need, so that the plate is allowed to move in an orderly manner according to a set pulling speed, thereby ensuring that the plate can flow out uniformly and stably. This is conducive to improving the production efficiency in subsequent molding and ensuring the quality of the plate, so that the entire production process is more flexible and controllable.

In this embodiment, the extruders are heated to make the thermoplastic elastomer materials and the composite materials reach a temperature 170 DEG C to 230 DEG C and in molten states; and flow velocities of the thermoplastic elastomer materials flowing out of the extruder and a flow velocity of the composite materials flowing out of the extruder are controlled at 300 to 500 KG/h.

By setting the above temperatures, the fluidity of the materials can be ensured, to prevent material decomposition or performance degradation, and controlling the flow velocities can further stabilize the production process to ensure the quality consistency of the product.

In this embodiment, a distance between the two molding embossing rollers is 1.5 to 5.0 mm.

Through the above settings, the appropriate distance can be selected to meet different usage requirements.

For example, when the distance is set to be close to 1.5 mm, a thinner protective mat can be manufactured, which is suitable for an automotive interior part with a high space requirement. When the distance approaches 5.0 mm, a thicker protective mat can be manufactured, which is more suitable for a scenario of a cargo hopper that requires high buffering performance and wear resistance.

In this embodiment, a pulling speed of the pulling device is 0.8 to 11 meters/minute.

Through the above settings, it can ensure that the plate is extruded at a relatively stable speed. This helps ensure the uniformity of the plate in a thickness direction. Due to the ranges of the flow velocities and the pulling speed, the molding process of the plate can be precisely controlled, which helps manufacture protective mats in different shapes and sizes according to the design requirements of the automotive protective mat.

In this embodiment, the thermoplastic elastomer material in the composite material is a styrene thermoplastic elastomer material, and the polyolefin material in the composite material includes a polyethylene material and polypropylene material.

By the above arrangement, since the styrene thermoplastic elastomer material is used as one of the components of the composite material, due to the characteristic of the molecular structure of the styrene thermoplastic elastomer material, the styrene thermoplastic elastomer material can be better blended with the polyolefin material. During manufacturing, when the materials are extruded through extruders and aggregated in a composite die head, a uniform composite structure can be formed, which helps avoid the problems such as material delamination and separation, making the performance of the composite reinforcement layer 2 more stable and reliable. Furthermore, by using the polyethylene material and the polypropylene material as the components of the composite material, due to their high hardness and rigidity, the polyethylene material and the polypropylene material can provide a necessary supporting force for the protective mat in the composite reinforcement layer 2 of the automotive protective mat.

In this embodiment, the polyethylene material in the composite material accounts for 20%; the polypropylene material in the composite material accounts for 20%; and the styrene thermoplastic elastomer material in the composite material accounts for 60%.

By the above arrangement, it is possible to further improve the flexibility of the automotive protective mat using the ratios, which is suitable for a scenario with a high flexibility requirement.

In this embodiment, the polyethylene material in the composite material accounts for 25%; the polypropylene material in the composite material accounts for 25%; and the styrene thermoplastic elastomer material in the composite material accounts for 50%.

By the above arrangement, the flexibility and rigidity of the automotive protective mat using the ratios can be moderate, making it suitable for many scenarios.

In this embodiment, the polyethylene material in the composite material accounts for 25%; the polypropylene material in the composite material accounts for 20%; and the styrene thermoplastic elastomer material in the composite material accounts for 55%.

By the above arrangement, it is possible to further improve the rigidity of the automotive protective mat using the ratios, which is suitable for a scenario with a high rigidity

In this embodiment, patterns are arranged on the molding embossing rollers.

By the above arrangement, the antiskid performance of the automotive protective mat can be further improved, and the patterns can also increase the aesthetic appeal of the automotive protective mat.

In this embodiment, one of the variable-frequency control systems controls flow velocities of the thermoplastic elastomer materials flowing out of the composite die head, a flow velocity of the composite material flowing out of the composite die head, and speeds of the molding embossing rollers; the flow velocities of the thermoplastic elastomer materials flowing out of the composite die head and the flow velocity of the composite material flowing out of the composite die head are 25 to 50 meters/minute; and the speeds of the molding embossing rollers are 9.0 to 12 meters/minute.

By the above arrangement, the thickness of the plate of the automotive protective mat can be precisely controlled to ensure the flatness of a surface of the plate.

As described above, one or more embodiments are provided in conjunction with the detailed description, The specific implementation of the present disclosure is not confirmed to be limited to that the description is similar to or similar to the method, the structure and the like of the present disclosure, or a plurality of technical deductions or substitutions are made on the premise of the conception of the present disclosure to be regarded as the protection of the present disclosure. Claims

1. An automotive protective mat, comprising:
a mat body, wherein the mat body comprises two elastic layers and a composite reinforcement layer; the composite reinforcement layer is located between the two elastic layers, and the elastic layers and the composite reinforcement layer are laminated; a shore hardness of the composite reinforcement layer is greater than a shore hardness of each elastic layer;
each elastic layer is made of a thermoplastic elastomer material, and the composite reinforcement layer is made of a composite material; components of the composite material comprise a thermoplastic elastomer material and a polyolefin material; and in the composite material, the thermoplastic elastomer material accounts for 50% to 60%, and the polyolefin material accounts for 40% to 50%.

2. The automotive protective mat according to claim 1, wherein each elastic layer is made of a styrene thermoplastic elastomer material.

3. The automotive protective mat according to claim 1, wherein the thermoplastic elastomer material in the composite material is a styrene thermoplastic elastomer material.

4. The automotive protective mat according to claim 3, wherein the polyolefin material in the composite material comprises a polyethylene material and a polypropylene material.

5. The automotive protective mat according to claim 4, wherein the polyethylene material in the composite material accounts for 20%; the polypropylene material in the composite material accounts for 20%; and the styrene thermoplastic elastomer material in the composite material accounts for 60%.

6. The automotive protective mat according to claim 4, wherein the polyethylene material in the composite material accounts for 25%; the polypropylene material in the composite material accounts for 25%; and the styrene thermoplastic elastomer material in the composite material accounts for 50%.

7. The automotive protective mat according to claim 4, wherein the polyethylene material in the composite material accounts for 25%; the polypropylene material in the composite material accounts for 20%; and the styrene thermoplastic elastomer material in the composite material accounts for 55%.

8. The automotive protective mat according to claim 1, wherein antiskid patterns are arranged on one side of one of the elastic layers facing away from the composite reinforcement layer.

9. The automotive protective mat according to claim 1, wherein the mat body is integrally formed.

10. A method for manufacturing an automotive protective mat, comprising the following steps:
S1: first extruding two layers of thermoplastic elastomer materials that are in molten states by using one extruder, and extruding a layer of composite material that is in a molten state by using another extruder, wherein components of the composite material comprise a thermoplastic elastomer material and a polyolefin material; and in the composite material, the thermoplastic elastomer material accounts for 50% to 60%, and the polyolefin material accounts for 40% to 50%;
S2: aggregating the three layers of materials in a composite die head, and extruding the materials under a pressure;
S3: pressing the thermoplastic elastomer materials and the composite material by using two molding embossing rollers to form a plate including two elastic layers and a composite reinforcement layer, wherein each elastic layer is made of the thermoplastic elastomer material, and the composite reinforcement layer is made of the composite material; and
S4: cutting the plate to form the automotive protective mat.

11. The method for manufacturing the automotive protective mat according to claim 10, wherein step S3a is further comprised between step S3 and step S4: pulling the plate by using a pulling device.

12. The method for manufacturing the automotive protective mat according to claim 10, wherein the extruders are heated to make the thermoplastic elastomer materials and the composite materials reach a temperature 170 DEG C to 230 DEG C and in molten states; and
flow velocities of the thermoplastic elastomer materials flowing out of the extruder and a flow velocity of the composite materials flowing out of the extruder are controlled at 300 to 500 KG/h.

13. The method for manufacturing the automotive protective mat according to claim 10, wherein a distance between the two molding embossing rollers is 1.5 to 5.0 mm.

14. The method for manufacturing the automotive protective mat according to claim 11, wherein a pulling speed of the pulling device is 0.8 to 11 meters/minute.

15. The method for manufacturing the automotive protective mat according to claim 10, wherein the thermoplastic elastomer material in the composite material is a styrene thermoplastic elastomer material, and the polyolefin material in the composite material comprises a polyethylene material and polypropylene material.

16. The method for manufacturing the automotive protective mat according to claim 10, wherein the polyethylene material in the composite material accounts for 20%; the polypropylene material in the composite material accounts for 20%; and the styrene thermoplastic elastomer material in the composite material accounts for 60%.

17. The method for manufacturing the automotive protective mat according to claim 10, wherein the polyethylene material in the composite material accounts for 25%; the polypropylene material in the composite material accounts for 25%; and the styrene thermoplastic elastomer material in the composite material accounts for 50%.

18. The method for manufacturing the automotive protective mat according to claim 10, wherein the polyethylene material in the composite material accounts for 25%; the polypropylene material in the composite material accounts for 20%; and the styrene thermoplastic elastomer material in the composite material accounts for 55%.

19. The method for manufacturing the automotive protective mat according to claim 10, wherein patterns are arranged on the molding embossing rollers.

20. The method for manufacturing the automotive protective mat according to claim 11, wherein one of the variable-frequency control systems controls flow velocities of the thermoplastic elastomer materials flowing out of the composite die head, a flow velocity of the composite material flowing out of the composite die head, and speeds of the molding embossing rollers; the flow velocities of the thermoplastic elastomer materials flowing out of the composite die head and the flow velocity of the composite material flowing out of the composite die head are 25 to 50 meters/minute; and the speeds of the molding embossing rollers are 9.0 to 12 meters/minute.
